(19) United States
(12) Patent Application Publication
(10) Pub. No.: US 2006/0256130 A1
(43) Pub. Date: Nov. 16, 2006

(54) Multimedia publishing system for wireless devices

(75) Inventor: Ruben Gonzalez, QUEENSLAND, (AU)

Correspondence Address: SUGHRUE MION, PLLC, 2100 PENNSYLVANIA AVENUE, N.W., SUITE 800, WASHINGTON, DC, 20037, US

(73) Assignee: ACTIVESKY, INC.

(21) Appl. No.: 10/498,558

(22) PCT Filed: Dec. 13, 2002
(86) PCT No.: PCT/AU02/01694

§ 371 Date: May 10, 2005

(30) Foreign Application Priority Data
Dec. 14, 2001 (AU) PR 9477

(51) Int. Cl. G09G 5/00

(52) U.S. Cl. 345/619

(57) ABSTRACT

A dynamic publishing system for delivery and presentation of multimedia on a wireless device, such as a PDA or mobile telephone. A presentation server dynamically compiles application data based on scene description data for one or more media objects, and sends the application data to the wireless device for presentation of the media objects. The wireless device has a media player that is able to process the application data at an object level for the objects in response to events, and control the presentation. The application data includes content, layout and control logic data for the media objects.

### FIELD OF THE INVENTION

The present invention relates to a publishing system, and in particular to a publishing system for publishing single and multiuser interactive and dynamic multimedia presentations and applications to wireless devices such as cellular phones.

### BACKGROUND

A significant problem for publication of rich audio and visual content to mobile devices results from the significant variations in mobile device capabilities, network capabilities, device operating systems and the difficulty in creating dynamic, interactive media based content. Unlike world-wide web (WWW or WAP content that is predominately text based, rich media is more sensitive to device capabilities such as display properties and computing power limitations. Existing mobile computing/application platforms such as BREW (Binary RunTime Environment for Wireless) and J2Me (Java™ 2 Micro Edition) lack key multimedia support. They also only mainly support static downloadable applications. Many content providers would like to extend their content and brands into the mobile space but the lack of consistent support across devices and the limited computing ability of these devices make them unable to composite and render multimedia content.

Current wireless publishing and distribution is limited to one of three basic models: browsing/text page download via HTML/WAP, streaming media as per MPEG, and application download via JAVA/Flash. Messaging may be used in conjunction with these to prompt and direct users to utilise services. These models are essentially very different and content publishers need to utilise all three if they wish to provide a rich service offering to consumers. In addition to being an expensive and complex proposition, this does not present a consistent user experience, with notable demarcations in user interface and functionality between each modality in a single publisher's service offering.

In the browsing/download data model of WAP/xHTML, users are limited to pulling down single pages of static text (with some image data) at a time, which provides limited functionality to the user. While the data content can be delivered to almost any handset, this ability also comes at the expense of content restrictions and layout limitations, making publisher service differentiation difficult. The processes and systems associated with this model are limited to the delivery of layout and content information to a device, without any function or logic code.

The streaming media model is similar to ‘pay per view’ television, but the user experience is significantly impeded by device and bandwidth limitations. Distribution of streaming media is currently limited to niche market mobile devices and provides a passive and expensive user experience. The systems and processes of this model are essentially limited to the delivery of content, without any layout information or logic.

Application download presents a “shareware” class software-publishing model. Like all application software, it is highly functional but must be custom written using complex development tools targeting a single purpose and a specific handset. These are typically fairly static with a limited lifecycle. Downloading of applications relates to the delivery of logic, but does not involve the controlled delivery of content and layout information.

The main problems that publishers are currently faced with when attempting to build differentiated sophisticated revenue generating applications and services are that they are predominantly limited to:

(i) Download (Pull) based delivery;

(ii) Full screen updates only which are unnecessarily slow and costly;

(iii) Fixed or constrained user interfaces;

(iv) Limited multimedia capabilities;

(v) Lack of portability across handsets;

(vi) Complex manual development for sophisticated applications;

(vii) Mainly static applications and content; and

(viii) No clear path to sustainable revenue.

Existing publishing/distribution platforms are predominantly designed for a single media type based on either text (WAP, HTML), vector graphics (FLASH, SVG), or video (MPEG4). Hence to create a rich and varied experience like that found on the World Wide Web requires bringing an assortment of different standard and proprietary technologies that were designed for desktop class computer terminals together using simple yet limiting interfaces. Unfortunately, these solutions are too demanding to work on mobile handsets and can only provide a limited multimedia experience, limiting the class of applications/content that can be delivered and creating the need for multiple solutions.

Apart from delivering content, these technologies provide very limited user functionality and layout capabilities (excepting SVG and Flash); hence they avoid providing the essential separation of content from functionality and form (layout or structure) needed for simple authoring of advanced applications. This means that the layout or structure of an application cannot be changed without also changing (or at least restating) its entire content and all its functionality, and explains why these technologies only operate in page mode. This significantly constrains the ability to create dynamic applications and limits the sophistication of applications that can be created.

Most of the existing publishing systems also have limited or poor multiuser capabilities. In the case of the HTML/WAP model, which is download based, the system does not lend itself to real-time interaction between multiple users since users must redownload a new content page to receive updates leading to inter-user sycnhronisation problems. In the case of streaming video multiuser, support is limited to either noninteractive media broadcasts or to multiparty video conferencing which does not include shared applications and workspaces. Downloadable applications such as those built using Java and Flash are inherently single user.

In the context of the present specification, the term “multimedia” is taken to mean one or more media types, such as video, audio, text and/or graphics, or a number of media objects.

It is desired to provide a publishing system or process that alleviates one or more of the above difficulties, or at least provide a useful alternative.

### SUMMARY OF THE INVENTION

In accordance with the present invention, there is provided a publishing system for multimedia, including a presentation server for dynamically compiling application data based on scene description data for one or more media objects, and for sending said application data to a wireless device for presentation of said one or more media objects.

The present invention also provides a media player for a wireless device, including a virtual machine for receiving application data for one or more media objects, processing said application data at an object level for said objects in response to detected events and presenting said objects on said device based on said events.

The present invention also provides a publishing system for multimedia, including a presentation server for synchronously accessing media sources to compile packets for media objects, sending said packets to a wireless device to execute an application using the packets received, and adjusting compilation of said packets whilst said wireless device runs said application.

The present invention also provides a publishing system for multimedia, including a presentation server for incrementally linking media sources for media objects, and sending said media objects incrementally to a wireless device running an application using the objects.

The present invention also provides a publishing system having a presentation server for simultaneously sending application data to a plurality of wireless devices running an application using the application data.

### BRIEF DESCRIPTION OF THE DRAWINGS

Preferred embodiments of the present invention are hereinafter described, by way of example only, with reference to the accompanying drawings, wherein:

FIG. 1 is a block diagram of a preferred embodiment of a dynamic multimedia publishing system (DMPS);

FIG. 2 is a block diagram of a media player client of the DMPS;

FIG. 3 is a block diagram showing data flows to and from a client engine of the media player client;

FIG. 4 is a block diagram of a presentation server of the DMPS;

FIG. 5 is a block diagram of an application server of the DMPS; and

FIG. 6 is a schematic diagram illustrating a tiled image feature of the DMPS.

### DETAILED DESCRIPTION OF THE PREFERRED EMBODIMENT

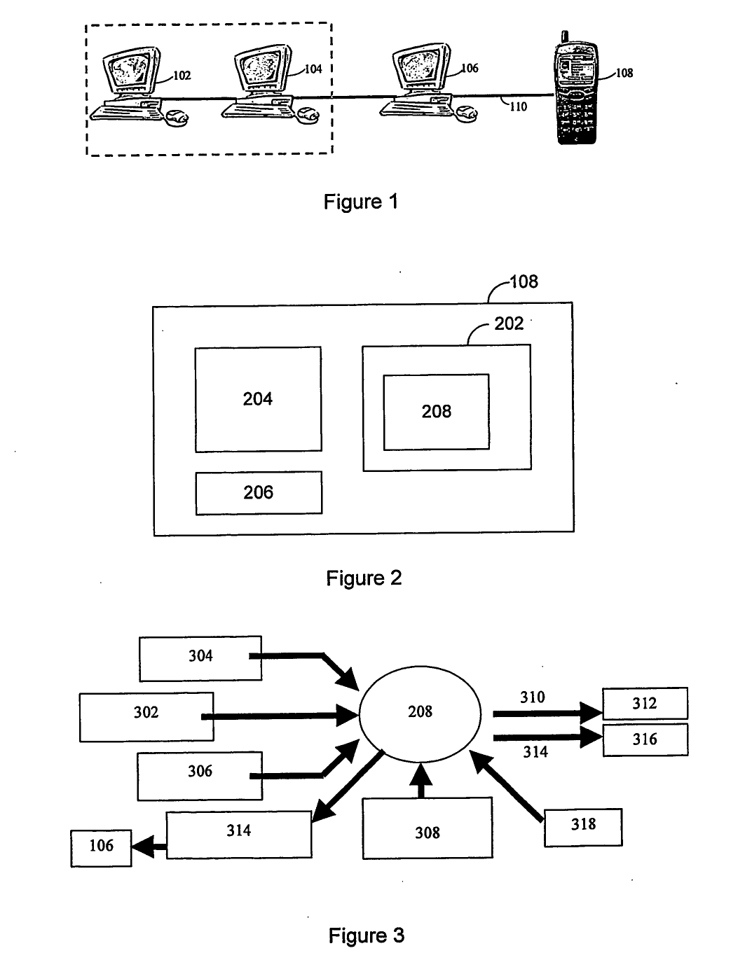

As shown in FIG. 1, a dynamic multimedia publishing system (DMPS) includes a database server 102, an application server 104, a presentation server 106, and a media player of a wireless client device 108. The application server 104 may communicate with a database server 102. The DMPS executes a dynamic multimedia publishing process that generates and executes dynamic multimedia applications with the following features:
(i) Dynamic content. This permits various types of media sources to be remapped to display objects in real time, which then update automatically as the source or “live” data changes.
(ii) Dynamic structure. This allows changes to the layout of on-screen media objects, or the creation and removal from the screen of new media objects, based on definable events.
(iii) Dynamic functionality. The behavior of the application or media objects can change, based on user or external events. Based on control packets sent to the wireless device 108, the user interface generated by the media player can be altered in real-time as content is presented.

The DMPS allows the delivery of content, layout, and function or logic information to a wireless device, the delivery of which can be dynamically controlled by the presentation server 106 and/or the client device 108 on the basis of delivery events or requests sent from the client device 108.

Using a scene based metaphor, the DMPS permits the creation of complex interactive applications, where an application is defined as a non-linear sequence of scenes. Each scene defines a spatio-temporal space in which media type or objects can be displayed. An object can represent any kind of live or static media content, including a combination of graphics (SVG), text & forms (HTML), MIDI, audio, tiled images, and video. A scene provides a framework for describing the structure or relationships between a set of media objects and their behavior. An XML scene description defines these relationships, which include object synchronization, layout and interactions.

The DMPS operates on individual media objects and permits authors to assign conditional event based functional behaviors to objects, and to define the interactions with objects to trigger these behaviors. Users, the system, or other objects can interact with any defined object to invoke whatever function the author has defined. Object behaviors can in turn be targeted to act on the system, other objects, or themselves to alter the application structure, media content or assigned functional behaviors. Hence users can create applications that have whatever content, functionality and structure they desire but also applications that contain any combination of dynamic content, dynamic function or dynamic structure.

This flexibility permits the creation of highly sophisticated and interactive applications that require advanced user interfaces such as video games. Since these can be created using text-based HTML like authoring that can be fully automated, their development requires significantly less time and cost than is required using handcrafted low-level programming.

Because the DMPS deals with objects, only displayed media objects that are changing are updated, for example, streaming text to individual text fields. This reduces latency and costs for users because the same information does not need to be resent to update the display. This is ideal for push based live-data feed applications.

In the described embodiment, the database server 102, application server 104, and presentation server 106 are standard computer systems, such as an Intel™ x86-based servers, and the wireless client device 106 is a standard wireless device such as a personal data assistant (PDA) or a cellular mobile telephone. The computer systems 102 to 106 communicate via a communications network such as the Internet, whereas the wireless device 108 communicates with the presentation server 106 via a 2G, 2.5G, or 3G wireless communications network. The dynamic multimedia publishing process is implemented as software modules stored on non-volatile storage associated with the servers 102 to 106 and wireless client device. However, it will be apparent that at least parts of the dynamic multimedia publishing process can be alternatively implemented by dedicated hardware components, such as application-specific integrated circuits (ASICs). The presentation server 106 is fully scalable, is implemented in J2SE release 1.4, and runs on any platform that supports a compatible Java Virtual Machine, including Solaris 8 and Linux.

In the DMPS, the presentation logic is split between the client device 108 and the presentation server 106. The presentation server 106 reads an XML-based scene description in SMIL (Synchronised Multimedia Integration Language, as described at http://www.w3.org/AudioVideo , IAVML (as described in International Patent Application PCT/AU/00/01296), or MHEG (Multimedia and Hypermedia information coding Expert Group, as described at http:/www.mheg.org), that instructs the presentation server 106 to load various individual media sources and dynamically create the described scene by resolving the screen/viewport layout and the time synchronisation requirements for each referenced media object. The presentation server 106 uses the scene description to synchronise and serialise media streams, and inject also control packets for the client device 108. The presentation server 106 uses the scene description to compile bytecode that is placed in the control packets. The bytecode of the control packets is able to instruct the client device concerning operations to be performed, and also provides layout and synchronisation information for the client. The scene description also refers to one or more media sources that have been prepared or encoded for transmission by the application server 104 or which can be obtained from a database. The bitstreams for the content of the sources is placed in media data packets for transmission. Media definition packets are also formatted for transmission. The media definition packets provide format information and coding information for the content of the media data packets. The media definition packets may also include bytecode instructions for initialising an application for the media player of the client device 108. Unlike the control packets, the bytecode does not control actions during running of the application by the player.

The actual bitstream 110 pushed to the client device 108 is also dependent on specific optimisations performed by the presentation server 106, which automatically packages the content for each different session and dynamically adapts during the session as determined by capabilities of the client device 108, network capability, user interaction and profile/location etc. The scene description script provided to the presentation server 106 can be dynamically generated by the application server 104, or can be a static file. The client device 108 receives the bitstream, which instructs the client device 108 how to perform the spatio-temporal rendering of each individual object to recreate the specified scene and how to respond to user interaction with these objects.

Media Player Client

As shown in FIG. 2, the client device 108 includes a media player including a media player client 202 and an object library 204, and an operating system 206. The media player client 202 decodes and processes defined media objects, event triggers, and object controls, and renders media objects. The media player 202 is a lightweight, real-time multimedia virtal machine that provides powerful multimedia handling capabilities to the client device 108 and maintains an ongoing session with the presentation server 106. The media player client 202 requires only 1 MIPS of processing power and 128 kb of heap space. Due to its small size of around 60 Kbytes, the media player client 202 can be provisioned over the air. The media player client 202 is able to run on a wide range of operating systems 206, including BREW, J2ME/MIDP, PPC, PalmOS, EPOC, and Linux.

The media player client 202 includes a client engine 208 that decompresses and processes the object data packet stream and control packet stream received from the presentation server 106, and renders the various objects before sending them to the audio and display hardware output devices of the client device 108. The client engine 208 also registers any events defined by the control packets and executes the associated controls on the relevant objects when the respective events are triggered. The client engine 208 also communicates with the presentation server 106 regarding the configuration and capabilities of the client device 108 and media player client 202, and also in response to user interaction.

Referring to FIG. 3, the client engine 208 performs operations on four interleaved streams of data: the compressed media data packets 302, the media definition packets 304, the object control packets 306, and upload executable code module packets 308. The compressed data packets 302 contain content, ie the compressed media object (eg video) data to be decoded by an applicable encoder/decoder (codec). The definition packets 304 convey media format and other information that is used to interpret the compressed data packets 302. For example, the definition packets may contain information concerning a codec type or encoding paramters, the bitstream format, the initial rendering parameter controls, transition effects, media format. The object control packets 306 provide logic, structure or layout instructions in bytecode for the client 202. The control packets define object behaviour, rendering, trigger events, animation and interaction parameters. The upload code module packets 308 contain executable software components (such as a specific codec) required to process the data contained in the other three packet types.

The specific packets sent to the client device 108 are determined by the presentation being viewed, as defined by the scene description, the capabilities of the client device 108 and the media player client 202, and user interaction with the presentation. The client engine 208 sends a series of frame bitmaps 310 comprising the rendered scenes to the client device 108's display buffer 312 at a constant frame rate, when required. It also sends a stream of audio samples 314 to the audio output hardware 316 of the client device 108. The client engine 208 also receives user events and form data 318 in response to user input. It monitors registered trigger events, executes the associated object controls, and returns relevant events, form data and device/client information 314 back to the presentation server 106. The media player client 202 also maintains the local object library 204 for use during presentations. The object library 204 is managed by the presentation server 106.

Unlike most virtual machines (eg Sun's JVM or Microsoft's Net CSharp VM), the media player client 202 operates on media objects at an object level. Like other virtual machines, it executes instructions using predetermined bytecode. However, unlike conventional virtual machines that are stack based and operate on numbers, the media player client 202 is not stack based, but is an event driven virtual machine that operates at a high level on entire media objects. Thus it avoids spending time managing low level system resources.

The media player client 202 permits highly optimized bytecode to be run in real-time without the overheads of having to interpret and resolve rendering directives or perform complex synchronization tasks, unlike existing browser technologies, allowing it to provide advanced media handling and a sophisticated user experience for users. Being fully predicated, it supports conditional execution of operations on media objects based on user, system and inter-object events. Hence it can be used to run anything from streaming video to Space Invaders to interactive game-casts.

The media player client 202 handles a wide variety of media types, including video, audio, text, Midi, vector graphics and tiled image maps. Being codec independent and aware, any compressed data is transparently decoded on an as needed basis, as long as codec support exists in the media player client 202 or is accessible on the client device 108.

In stand-alone mode, the media player client 202 can play any downloaded and locally stored application. In client-server mode, the media player client 202 establishes a (low traffic) two-way connection with the presentation server 106 for the duration of an online application's execution. The media player client 202 executes instructions as they arrive in real-time, instead of waiting to download the entire application first. This allows delivery of sophisticated multimedia applications on simple handsets.

The media player client 202 also performs full capability negotiation with the presentation server 106 so that the latter knows how to optimise the data it sends to the media player client 202 to achieve the best possible performance on the client device 108, given the latter's limitations and network conditions. It also provides security features to provide digital rights management functions for publishers.

Presentation Server

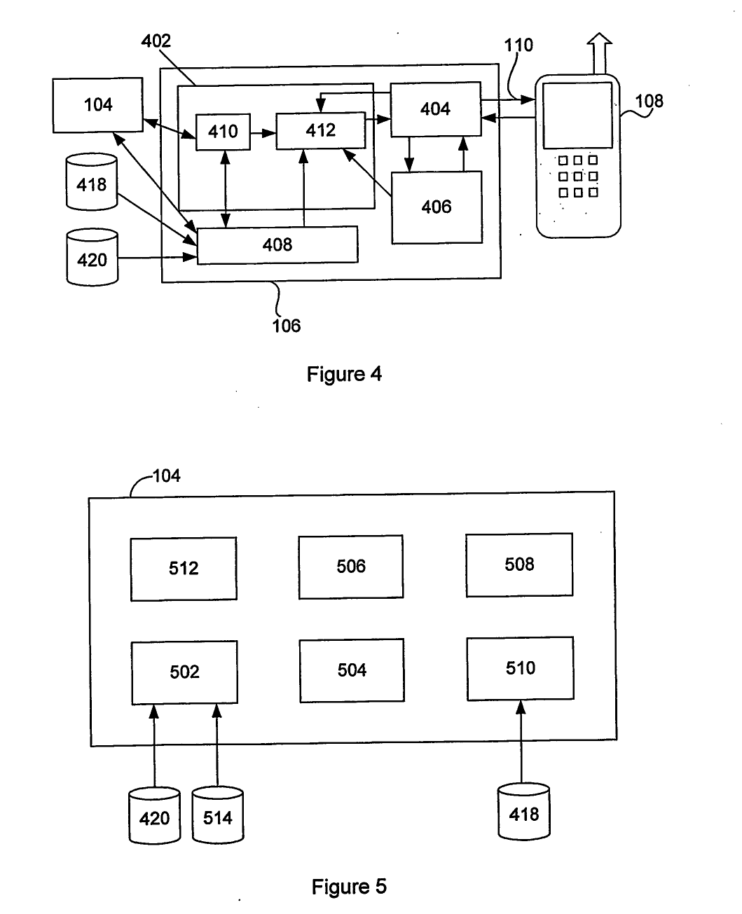

As shown in FIG. 4, the presentation server 106 includes a dynamic media compositor (DMC) engine 402, a stream transport module 404, a capability negotiator 406, and a storage manager and buffer 408. The DMC engine 402 includes a just-in-time XML compiler 410, and a DMC 412. The presentation server 106 has four interfaces: a media player connection interface provided by the transport module 404 (TCP, UDP or HTTP), a scene description interface to at least a scene database 418 (HTTP/HTTPS), a source media interface to a media file database 420 (HTTP), and a management interface (HTTP/HTTPS) to the application server 104.

The XML compiler 410 accepts as input a scene description 418 which can be in a binary format, but is typically in an XML-based language, such as SMIL or IAVML, or in MHEG. The scene description 418 can be a static file or dynamically generated by the application server 104. The XML scene description 418 defines the specific media objects in a scene, including their spatial layout and time synchronisation requirements, the sequence of scenes, and the user controls and actions to be executed by the media player client 202 when control conditions (events) are met for a given presentation. The XML scene description 418 also defines how event notifications and user form data is to be handled by the presentation server 106 at runtime. The XML compiler 410 compiles the XML scene description 418 into control bytecode for the media player client 202, and also generates instructions for the DMC 412 concerning the media sources that need to be classed and synchronised.

The DMC 412 acts as a packet interleaving multiplexor that fetches content and definition data for the referenced media sources, adds the control bytecode, forms packets, drops any packets that are not necessary, and serialises all the data as a bitstream for transport by the transport module 404. The DMC 412 interleaves the bytecodes and synchronised media data from referenced media sources 420 to form a single, secure and compressed bitstream 110 for delivery to the media player client 202. The media source objects 420 can be in compressed binary form or in XML. In the latter case, the application server 104 generates a binary representation of the media object and caches it in the buffer 408. The buffer 408 acts as a storage manager, as it receives and caches compressed media data and definition data accessed from the source database 420 or the application server 104. The application server 104 is used to encode, transcode, resize, refactor and reformat media objects, on request, for delivery by the presentation server 106. The transcoding may involve media conversion from one media type to another.

Back-channel user events from the media player client 202 can be used to control the DMC 412. In particular, the DMC engine 402 generates the presentation bitstream 110 by dynamically compositing the source objects based on the scene description as well as the device hardware execution platform, current client software capabilities and user interaction. The presentation server 106 constantly monitors the network bandwidth, latency and error rates to ensure that the best quality of service is consistently delivered. The capability negotiator 406, based on information obtained from the transport module 404, is able to instruct the DMC 412 concerning composition of the stream. This may involve adjusting the content, control or the media definition packets, or dropping packets as required.

If the media player client 202 does not have the capability to render the presentation bitstream 110, then the required executable modules/components are inserted into the bitstream 110 by the DMC 412 to be uploaded to the media player client 202. These modules/components are stored on the database 420 and uploaded to the media player client 202 based on the capability negotiation process of the negotiation 406 which determines the following three things:
(i) the hardware execution platform of the client device 108;
(ii) the current capabilities of the media player client 202; and
(iii) the capabilities required to play the target presentation.

The negotiator 406 uses this capability information to select and instruct delivery of the appropriate loadable software module to the media player client 202, if required, in code packets 308. In addition to the upload code and compressed binary media content and a variety of standard XML content descriptions (such as HTML 2.0, SVG, MusicXML, NIFF etc) the presentation server 106 can read a range of other native binary formats, including MIDI, H.263 and MPEG4 from the databases 418, 420 or application server 104. In most cases, the server 106 reads the format and encapsulates/repackages the binary content data contained therein ready for delivery to the media player client 202 with no alteration of the bitstream 110 if there is native support on the media player client 202 to process it.

The core function of the DMC 402 is to permit the composition of individual elementary presentation media objects into a single, synchronous bitstream stream 110 for transmission to the media player client 202, as described in International Patent Application PCT/AU/00/01296. The DMC 412 forms the media data packets 302, media definition packets 304, object control packets 306, and the upload code module packets 308, based on instructions received from the compiler 410, the negotiator 406 and event data (that may be provided directly from the transport module 406 or from the negotiator 406).

The DMC engine 402 permits presentation content to be adapted during a session, while streaming data to the media player client 202, based on instantaneous user input, predefined system parameters, and capabilities of the network, media player client 202, and/or client device 108. Unlike the application server 104 that dynamically adapts individual scene descriptions based on data sources from either returned user form data or an external data source, the DMC engine 402 adapts based on events (such as mouse clicks), capabilities or internal system (client 108 and presentation server 106 ) based parameters. Specifically, the DMC adaptation encompasses the following:
(i) adjusting the content media types or temporal or spatial quality of the presentation based on capabilities of the client device 108, by passing capability information back to the application server's transcoding process;
(ii) adjusting content to varying bit rate requirements of the wireless channel at defined time intervals, by dropping of data packets containing temporal scalability or spatial scalability enhancement information;
(iii) inserting, replacing or deleting individual video or other media objects in presentation scene, by replacing individual media input data streams during run-time in response to defined events;
(iv) jumping to new scenes in the presentation, and hyper-linking to new presentations, by retrieving and compiling new application descriptions;
(v) inserting, replacing or deleting individual animation and object control parameters or event triggers, as defined in an application description; and
(vi) managing the object library on the client device 108.

The scene description can dynamically request XML-based content (eg text, vector graphics, MDI) or “binary” object data (any form with or without object controls) to be composited into an executing presentation. While the XML compiler 410 can be viewed as a compiler in the tranditional sense, the DMC 412 can be viewed as an interactive linker which packages object bytecode together with data resources for execution. The linker operates incrementally during the entire execution of a server-hosted application and its operation is predicated on by real-time events and parameters. It also incrementally provides the executable code and data to the running client on an “as needed basis”. This also allows the presentation server 106 to synchronously or asynchronously push object update data to a running application instead of updating the entire display.

The DMC or “linker” synchronously accesses any required media resources as needed by a running application, interactively and dynamically packaging these together with the application code into a single synchronous bitstream. The interactive packaging includes the predicated and event driven insertion of new media resources, and replacement of removal of individual media resources from the live bitstream.

These content object insertions can be an unconditional static (fixed) request, or can be conditional, based on some user interaction as a defined object behavior to insert/replace a new object stream or a user form parameter that is processed inside the DMC engine 402.

The presentation server 106 can operate as a live streaming server, as a download server, or in a hybrid mode, with portions of an application being downloaded and the remainder streamed. To provide this flexibility, the platform is session based, with the media player client 202 initiating each original request for service. Once a session is established, content can be pulled by the media player client 202 or pushed to the media player client 202 by the presentation server 106.

The presentation server 106 has a number of key and unique roles in creating active applications that respond in real-time to a range of user or system events. Those roles include:
(i) dynamic binding of media resources to display objects in the application;
(ii) routing of live data to objects to push updates to the screen;
(iii) managing the just-in-time delivery of content, and application bytecodes to the media player client 202 to reduce network latency;
(iv) managing media player client 202 caches and buffers to reduce unnecessary data transfers;
(v) run-time creation and removal of onscreen objects;
(vi) run-time assignment and management of object behaviors;
(vii) run-time control of scene layout; and
(viii)real-time adaptation of data being transmitted to the media player, based on network bandwidth, handset capabilities, or system (e.g., location/time) parameters.

AU of these functions of the DMC engine 402 are interactively controlled during execution of an application by a combination of internal system, external data and/or user events.

Application Server

The application server 104 monitors data feeds and provides content to the presentation server 106 in the correct format and time sequence. This data includes the XML application description and any static media content or live data feeds and event notifications. The application server 104, as mentioned above, is responsible for encoding, transcoding, resizing, refactoring and reformatting media objects for delivery by the presentation server 106. As shown in FIG. 5, the application server 104 includes intelligent media transcoders 502, a JSP engine 504, a media monitor 506, a media broker 508, and an SMIL translator 510. The application server 104 is J2EE™-compliant, and communicates with the presentation server 106 via a standard HTTP interface. The Java™ 2 Platform, Enterprise Edition (J2EE™) is described at http://java.sun.com/j2ee.

The use of dynamic content, such as Java Server Pages (JSP) and Active Server Pages (ASP), with the application server 104 permits more complex dynamic presentations to be generated than the simple object insertion control of the presentation server 106, through the mechanism of parameterized functional outcalls (which return no data) made by itself to a database server 102 or by the presentation server 106 to the application server 104. The application server 104 processes these callout functions and uses them to dynamically modify a presentation or a media source, either by controlling the sequencing/selection of scenes to be rendered, or by affecting the instantiation of the next scene description template provided to the presentation server 106. For example, the scene description template can be customised during execution by personalization, localization, time of day, the device-specific parameters, or network capability.

While the main output of the application server 104 is a scene description (in SMIL, IAVML, or MHEG) 418, the application server 104 is also responsible for handling any returned user form data and making any required outcalls to the database server 102 and/or any other backend systems that may provide business logic or application logic to support applications such as e-commerce, including reservation systems, product ordering, billing, etc. Hence it interfaces to business logic 512 to handle processing of forms returned from the client device 108. The application server 104 is also responsible for accepting any raw XML data feeds and converting these to presentation content (eg graphics or text objects) via an XSLT process, as described at http://www.w3.org/TR/xslt.

As shown in FIG. 5, the application server 104 includes intelligent media transcoders 502, a JSP engine 504, a media monitor 506, a media broker 508, and an SMIL translator 510. It also interfaces to business logic 512 to handle processing of forms returned from the client device 108. The application server 104 is J2EE™-compliant, and communicates with the presentation server 106 via a standard HTTP interface. The Java™ 2 Platform, Enterprise Edition (J2EE™) is described at http://java.sun.com/j2ee.

Under the control of the media broker 508, intelligent transcoding between third party content formats and standard or proprietary formats permits existing media assets to be transparently adapted according to capabilities of the client device 108. The media broker 508 is an Enterprise Java Bean (EJB) that handles source media requests from the presentation server 106. It automates the transcoding process as required, utilizing caching to minimize unnecessary transcoding, and making the process transparent to users. The transcoders 502 are EJBs that support the following media and data formats: graphics (SVG, Flash), music (MIDI, MusicXML), images (JPEG, PNG, GIF, BMP), text/forms (xHTML, ASCII, HTMEL), video (AVI, H263, MPEG), audio (WAV, G.721, G.723, AMR, MP3), and alternate scene descriptions (SMIL, XMT).

The media monitor 506 handles asynchronous changing media sources such as live data feeds 514. It notifies the presentation server 106 of changes in the source media, so that it may reload the source media and update the content displayed in the media player 202, or, alternatively, jump to a different scene in a presentation.

Media Objects and Bitstreams

A media object can be defined by a set of media data packets, media definition packets and control packets, which are all identified by a unique tag.

In the presentation structure each media data packet contains all of the data required to define an instance of the media object element for a particular discrete point in time. In essence a packet encapsulates a single sample of the object element in time. Object control packets similarly encapsulate control signals that operate on the object at discrete instances in time and appear in correct time sequence within an object stream. This is true for all media objects except for tiled image data packets. With tiled images, described below, a media data packet primarily contains all of the data required to define an instance of the object for a particular region (instance) in space. While a tile image object as a whole is localised in time, each packet is primarily localised in space. This difference in the semantics of tile image data packets extends to object control packets as well where these are not localised primarily in time but in space, specifically mapping to individual image tile locations. Hence tile image control packets do not occur in time sequence in the format, but in space sequence, where following a tile image data packet, zero or more control packets that relate to the data packet may follow.

The definition packets define the structure and interpretation of media specific codec bit streams. The media data packets encapsulate the content in the form of compressed media elements.

The object control packets convey the functions or operations to be performed on content file entities that permit control over rendering, data transformation, navigation and presentation structures.

Media data entities may be either static, animated or evolving over time. The static case consists of a single, invariant instance and is a subset of animated, which provides for deterministic change from a discrete set of alternatives, often in a cyclical manner, whereas streaming is continuous, dynamic, non-deterministic evolution. The update in the case of animated or evolution may be time motivated or caused by some asynchronous update event. These three characteristics apply not just to the media content but also the structure and the control in a presentation. Examples of these characteristics in terms of the content are shown in Table 1.

TABLE 1

| | Time Motivated | |
|---|---|---|
| | Update | Event Driven Update |
| Static | — | Still Picture, Text Message |
| Animated | Video Sprite | Slide Show |
| Evolving | Streaming Video | Game-Cast Data-Feed |

For presentation content, support for static, animated and evolutionary data is provided by the DMPS system requirements for handling media elements:
(a) Static media is stateless and requires all the data that defines the element to be delivered in its entirety at one time to the client for rendering. Static media requires one definition and one data packet. This media type requires event based (random) access by the client. Both time and event driven updates are the same.
(b) Streaming media requires new incremental data to dynamically update the state of the element to create a new instance of it, and this is valid for a time interval before it must be renewed. Only the state of the current instance needs to be stored; it requires a single definition packet but an undefined number of data “update” packets that are sequentially accessed and processed by the client. Both time and event driven updates are essentially the same.
(c) Animated media is based on performing a discrete set of updates on a given media element. For media that is defined atomically these updates typically modify one or more atoms rather than create an entire new instance. The updates may occur in a predetermined order after which the element reverts to its original state and the process reiterated. In the case of time-based update the sequence is always constant (eg sprites) whereas in event-based update the sequence is typically random. Both random and sequential access is required for animations. To reduce unnecessary decoding and transport a definition packet and fixed number of decoded data packets is stored at the client, memory permitting. With event driven media animation, the simplest method to support this is through object replace controls on a single object from a set of streams.

For presentation structure, the need to support static, animated and evolutionary modification of scenes is supported via definition and object control packets:
(a) Static structure—This requires only one scene definition and fixed object definitions used.
(b) Streaming structure—This can be primarily achieved by replacing a scene with an entire new instance, as each scene must be self-contained. The alternative mechanism that provides incremental evolution uses object control mechanisms to dynamically create and delete objects within a given scene. This is achieved by using empty object templates that serve as targets for arbitrary object replace operations.
(c) Animated structure—This is more constrained than streaming and is supported through object controls to create a limited set of transitory structural alterations such as implicit object grouping. For example, events on one object can cause actions on various other objects and a single action be applied to multiple objects at once.

For presentation control, the need to support static, animated and evolutionary modification of function is supported via the object control packets:
(a) Static Control—This usually requires initial object controls to be present.
(b) Streaming Control—This usually requires new object controls to be available to replace existing ones.
(c) Animated Control—As this provides for a limited set of often-cyclical controls these can be predefined and supported via an animation extension to object definitions.
   Multiuser Support

In the case of publishing and delivering multi-user applications such as collaborative work environments or multi-user games the DMPS essentially operates in the same manner as for single user applications where the presentation server and media player in consort execute the presentation logic and the user interface while the application server hosts the application logic. Due to the flexibility and functionality requirements of typical interactive multiuser applications such as multiplayer games generally, these are normally built as highly customised and monolithic applications. The DMPS permits multiuser applications to be constructed with reduced effort since the user interface and presentation logic components are already present in the presentation server and the media player and the application server need only provide to each user the correct “view” of the application display data and available functionality at each instance in time. The presentation server also provides back to the application server the respective events from each user that is used to modify the shared application data. This is possible because as part of the capability negotiation each media player uniquely identifies itself to the presentation server using a user ID and this is passed to the application server when requesting the view of the shared data and passing events to the application server.

Download Applications

In the case of downloaded applications the essential difference from online applications is that the DMC 412 runs in batch mode and an application must be fully downloaded to the media player before execution of the application begins. Other than this the process is essentially the same as for online applications. When a client requests an application download the media player provides its capabilities to the presentation and publishing server. The publishing server transcodes and reformats the media as required for the specific handset and provides this to the presentation server for packaging up with the object controls, which processes the entire application and optionally cache the generated output bit stream to delivery to one or more devices.

In the case of a hybrid application a two stage creation process is required. First a “static” portion of the application is created for downloading to the application via a third party distribution mechanism, and the “dynamic” or online application is created.

The static downloaded portion of the application mainly consists of a start scene with one or more auxiliary scenes and an optional set of objects for preloading into the systems object library. This part of the application (static download portion) contains at the least the following:
(i) A startup scene with an automatic or event triggered sceneJump to a URI on the application's host server.
(ii) An optional library preload scene.
(iii) A valid uniqueAppID in a Scenedefn packet to identify the application.
(iv) Version number in the Scenedefn packet to identify the application.

When a JumpURI command is executed on the client, referrer data is passed to the target presentation server consisting at the least of the uniqueAppID. This permits the presentation server to know what preloaded resources are available on the client object library.

Tiled Image Support

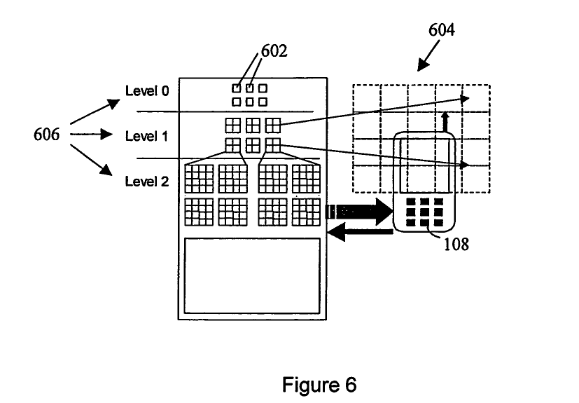

The DMPS provides tiled image support that permits advanced functions such as smooth panning and zooming with minimal transmission overhead, and video game support. As shown in FIG. 6, this is achieved by dividing source pictures at the presentation server 106 that exceed a reference picture size into small rectangles 602 to provide a tiled representation 604, where each tile can be managed separately. The entire image can exceed the display dimensions of the client device 108 by a significant amount, but only those tiles visible at any time need be delivered to the media player client 202 by the presentation server 106 and rendered. This eliminates unnecessary data transmission between the client device 108 and the presentation server 106. Specific features of this capability include:
(i) panning or scrolling in vertical, horizontal and diagonal directions;
(ii) zooming, which provides multiple levels of information, not only resolution. This is achieved by providing the tile data in a spatial scalable format that supports different layers of resolution in more than one direction. The tile data includes different tiles for different layers of resolution, and is generated by a codec that supports the spatial scalable format;
(iii) progressive display update (where supported by the codec) whereby the image is displayed as data is received, progressively increasing the image resolution;
(iv) spatial scalability, so that the system is capable of operating with client devices of various screen resolutions. The same view can be specified on different size screens (where supported by the codec).

Tile data can also be provided that allows larger images to be generated by the client device 108 from the tile data received. For example, a few tiles can be used in a video game to generate a larger scene image.

These image capabilities allow the DMPS to optimise the provision of data, as dictated by user requirements and device attributes particularly screen size). The user is able to navigate across a large image, zooming in and out as required, yet only receive the exact amount of data they require for the current display. This reduces both the response time and the data transmission costs. In addition, the media player client 202 updates the display with data as it is received, which allows the user to make choices/selections prior to receiving all the data for that screen, again reducing the response time and cost.

To provide this function, image data is stored on the presentation server 106 as a set of tiles 602 at various levels 606 of detail/resolution. This granular storage permits the relevant data components to be sent to the media player client 202 on an as-needed basis as the user navigates through the image by either zooming or panning. This can also be used to provide scrolling backgrounds for game applications. A directory packet stored with the image tiles defines the mapping between each tile and its coordinate location in the image. This also permits a single image tile to be mapped to multiple locations within the image, and specific object control/event trigger to be associated with each tile for supporting games.

Media Object Controls

Each media object in a presentation can have one or more controls associated with it, in addition to scene-based controls and image tile controls. Object controls include conditions and an action as a set of bytecodes that define the application of one or more processing functions for the object. The control actions are all parameterised. The parameters can be provided explicitly within the control itself, or they can be loaded from specific user registers. Each control can have one or more conditions assigned to it that mediate in the control action execution by the client software. Conditions associated with one object can be used to execute actions on other objects as well as itself. Table 2 provides the possible conditions that can be applied.

TABLE 2

| Condition | Description |
|---|---|
| Negate | If set the condition is negated |
| Unconditional | Execute action unconditionally |
| UserFlag | Test bits in system Boolean variables |
| UserValue | Test value of system integer |
| | register variables |
| UserEvent | Test for user events; e.g., |
| | specific key pressed, or pen event on |
| | various parts of objects, etc. |
| TimerEvent | Test for system timer event |
| Overlap | Test for object overlap and |
| | direction sensitive collision |
| | detection between objects |
| ObjLocation | Test for specific Object |
| | positioning on the screen |
| Source | Is data being streamed from |
| | a server or local play |
| PlayState | Is player paused or playing |
| BufferState | Is the buffer empty or full |

Table 3 provides the range of actions that may be executed include in response to a condition being met.

TABLE 3

| Actions | Process | Description |
|---|---|---|
| Protect | Local | Limit user interaction with object |
| JumpToScene | Either | Jump to new place in presentation/application |
| ReplaceObject | Local & | Replaces an object in the current scene with |
| | Remote | a different object, also add/delete objects |
| Hyperlink | Remote | Close presentation and open new one |
| Create/Destroy | Both | Enables the instantiation of new media objects |
| Object | | or the destruction of existing media objects |
| PurgeControls | Local | Resets the state of each object |
| SetTimer | Local | Initializes and starts a system timer |
| Animate | Local | Defines animation path for objects |
| MoveTo | Local | Relocate objects in scene |
| Zorder | Local | Change object depth order |
| Rotate | Local | Rotate objects in 3D |
| Alpha | Local | Change object transparency value |
| Scale | Local | Change object size |
| Volume | Local | Change sound volume of objects audio stream |
| Register | Local | Perform operation using values in system |
| Operation | | registers and object parameters |
| CondNotify | Remote | Notify server of the event or condition that |
| | | just occurred such as panning a tiled image - |
| | | or any of the other remotely processed actions |
| | | that have been invoked. |

Capability Negotiation

The capability negotiation between the media player client 202 and the presentation server 106, controlled by the negotiator 406, permits micro-control over what specific data is delivered to the media player client 202. This process is referred to as data or content arbitration, and specifically involves using the client device 108's capabilities at the presentation server 106 to:
(i) modify presentations in order to provide an optimal viewing experience on the client device 108, including packet dropping (temporal scalability), and resolution dropping (spatial scalability);
(ii) determine what presentation to send or what media to drop for devices that do not support particular media types; and
(iii) update or install appropriate software components in the client device 108. The upload components are treated as another media source by the DMC 412.

In the first instance of data arbitration, the data sent to the media player client 202 is adapted to match the existing capabilities of the client device 108 (eg processing power, network bandwidth, display resolution, and so on) and the wireless network. These properties are used to determine how much data to send to the client device 108 depending on its ability to receive and process the data.

A second instance of data arbitration depends on the support in the client device 108 for specific capabilities. For example, some client devices may support hardware video codecs, while others may not have any audio support. These capabilities may be dependent on both the client device hardware and on which software modules are installed in the client device. Together, these capabilities are used to validate content profiles stored with each presentation to ensure playability. Specifically, the profiles defined the following basic capabilities:
(i) installation of software updates;
(ii) digital rights protection;
(iii) interaction—includes multi-object;
(iv) audio support;
(v) music support;
(vi) text support;
(vii) video support; and
(viii) image support.

Additionally, the DMPS supports, at a high level, six pre-defined levels of interactive media capabilities, as provided in Table 4 below, providing various levels of required functionality. These are compared to the media player client 202 's capabilities to determine whether the application is supported. More detailed lower levels are also supported.

The content adaptation/arbitration modifies a presentation through the following mechanisms:
(a) Automatic Presentation Server DMC control over what specific packets to send/drop at any instance in a presentation, for example (packets providing temporal or spatial scalability).
(b) Automatic Publishing server transcoding and adaptation (ie rescaling) of source media as needed based on target device.

The capability negotiation process determines:
(a) What is the client's hardware execution platform (eg Screen size, CPU, memory etc).
(b) What the current client software capabilities are (eg player version, codecs, etc).
(c) What capabilities are required to play the target content as defined by a profile.
(d) Also network QoS at any instance during the session.

The DMPS executes the following process:
(i) A ConfigDefn packet is sent from the client to the presentation server at the start of a session.
(ii) Depending on information in ConfigDefn packet the presentation server may elect to query a device database to extract additional information not supplied in this packet. Alternatively it may elect to update information in device configuration database.
(iii) Depending on information in ConfigDefn packet the presentation server may elect to further query the device to ascertain the presence of specific codec or other component support.
(iv) The presentation server estimates channel bandwidth.
(v) The presentation server requests indicated presentation (scene+source media descriptors) by passing selected device config parameters to the application server.
(vi) The JSPs can be used to process the SMIL/IAVML according to the config parameters
(vii) When requesting media data the presentation server suitably instructs (codec, format etc) the application server transcoders to generate full quality elementary media compressed data files and deliver them to presentation server to be cached. It may return an access denied message if certain config parameters such as specific media type support are not met.
(viii)If a device does not have enough processing speed to render a particular compressed media data (video or audio) and the application server was unable to provide a more lightweight compression method then the device is considered incapable of supporting that media type
(ix) The presentation reads the generated compressed media data and dynamically drops selected packets during the presentation to meet the device capability and varying QoS constraints.

The application server executes the following process:
(i) JSP engine/SMIL decides whether presentation may be accessed by checking the following:
   a. Media type support capabilities (eg must have video etc);
   b. Specific Device (eg PDA vs handset or BREW vs J2ME)
   c. Specific network bandwidth (vs any target presentation bandwidth)
(ii) Transcoders encode media based on device capabilities including:
   a. Screen size based on both device display and presentation scaling mode
   b. CPU speed based on SkyMIPS device rating & codec performance requirements, eg
      i. for video on devices with 200 MIPS use H.263 video codec
      ii. for video on devices with 20 MIPS use ASG video codec
      iii. for video on devices with 1 MIPS use VLP video codec
      iv. for audio on devices with 200 MIPS use ACC audio codec
      v. for audio on devices with 20 MIPS use IMA audio codec
   c. Channel bit rate: adjust quality setting on codecs to achieve target bit rate limitations
   d. Platform limitations, for example
      i. For MIDP 1.0 platforms, transcode all text data and images into a PNG bitmap
      ii. For platforms with hardware codecs, either just encapsulate (repackage) the data into a binary file transcode into the supported codec if required

The DMC 412 of the presentation server executes the following process:
1. Upon a packet loss error automatically resend the following packet types: Any-Defn, ObjCtrl, VideoKey, ImageKey, ImageDat, TextDat, GrafDat, MusicDat (VideoKey and ImageKey are media data packets). The following are not resent VideoDat and its derivatives or AudioDat.
2. If there is a video packet loss then send next available VideoExtn (a data) packet to fix error else pause the presentation until next VideoKey packet.
3. If presentation data rate>available channel bit rate at any instance then drop video packets in the following order, first drop all VideoTrp (data) packets then drop all VideoDat packets, finally drop AudioDat. When videodat or audiodat packets are present tine synchronization is preserved, and presentation pauses during rebuffering minimized.

4. If a device does not support MusicDat or AudioDat then all music and audio packets present in the presentation are discarded.

TABLE 4

| Level | Name | Description |
|---|---|---|
| 0 | AudioVideo | Audio + video only, Single object, No ObjCtrl |
| 1 | ImageMap | Single image map based application only, |
| | | (pan, zoom) |
| 2 | Elementary | Single object, any media, no interaction |
| 3 | StillActive | Up to 200 objects, no continuous media |
| | | (i.e., audio/video) only text, music, images, |
| | | graphics hotspots, very limited interaction |
| | | (click, move, jump). |
| 4 | VideoActive | Limited interaction single video object |
| | | with transparent Vector graphics hotspots |
| | | only, very limited interaction (jumps). |
| 5 | Interactive | Multi-object, per object controls |

The simplest implementation (AudioVideo at level 0) provides a passive viewing experience with a single instance of media and no interactivity. This is the classic media player where the user is limited to playing, pausing and stopping the playback of normal video or audio. The StillActive and VideoActive levels add interaction support to passive media by permitting the definition of hot regions for click-through behaviour. This is provided by creating vector graphic objects with limited object control functionality. Hence the system is not literally a single object system, although it would appear so to the user. Apart from the main media object being viewed transparently, clickable vector graphic objects are the only other types of objects permitted. This allows simple interactive experiences to be created such as non-linear navigation, etc. The final implementation level (level 5, Interactive) defines the unrestricted use of multiple objects and full object control functionality, including animations, conditional events, etc. and requires the implementation of all of the components.

The third instance of data arbitration includes capability negotiation. This involves determining what the current software capabilities are in the media player client 202 and installing new functional modules to upgrade the capabilities of the media player client 202. This function involves the presentation server 106 sending to the media player client 202 data representing the executable code that must be automatically installed by the media player client 202 to enhance its capabilities by adding new functional modules or updating older ones.

Many modifications will be apparent to those skilled in the art without departing from the scope of the present invention as herein described with reference to the accompanying drawings. For example, the presentation server 104 may incorporate all the functionality and components of the application server 106

1. A publishing system for multimedia, including a presentation server for dynamically compiling application data based on scene description data for one or more media objects, and for sending said application data to a wireless device for presentation of said one or more media objects.

2. A publishing system as claimed in claim 1, wherein said application data includes content, layout and control logic data for said media objects.

3. A publishing system as claimed in claim 2, wherein said presentation server communicates with said wireless device and said compiling is controlled on the basis of communications between said presentation server and said wireless device.

4. A publishing system as claimed in claim 1, wherein said compiling is controlled during delivery of said application data to said wireless device.

5. A publishing system as claimed in claim 4, wherein said control logic data comprises bytecode for a virtual machine of said wireless device, and said application data is for content requested by said wireless device and is adjusted in real-time during said compiling on the basis of events detected by said virtual machine.

6. A publishing system as claimed in claim 5, wherein said events are defined by said logic data.

7. A publishing system claimed in claim 6, wherein said events relate to actions of a user of said wireless device.

8. A publishing system as claimed in claim 1, wherein said scene description data defines one or more scenes including one or more media objects, rendering of said one or more media objects and one or more events associated with said one or more multimedia objects.

9. A publishing system as claimed in claim 8, wherein said application data includes interleaved control packets, media data packets and media definition packets for said media objects.

10. A publishing system as claimed in claim 8, wherein said scene description data includes XML data.

11. A publishing system as claimed in claim 3, wherein said compiling is adjusted on the basis of one or more characteristics of the communications link between said presentation server and said wireless device.

12. A publishing system as claimed in claim 3, wherein said presentation server is adapted to receive capability data from said wireless device indicating capabilities of said wireless device and to modify said application data on the basis of said capability data.

13. A publishing system as claimed in claim 12, wherein said capabilities include hardware capabilities and software capabilities of said wireless device.

14. A publishing system as claimed in claim 13, wherein said presentation server is adapted to send software packets to said wireless device on the basis of said capability data to modify software capabilities of said wireless device.

15. A publishing system as claimed in claim 1, wherein said presentation server is adapted to manage a multimedia object library stored on said wireless device.

16. A publishing system as claimed in claim 2, wherein said presentation server is adapted to receive user form data and events from said wireless device.

17. A publishing system as claimed in claim 1, including an application server for communicating with said presentation server, providing encoded data for said media objects, and generating said scene description data.

18. A publishing system as claimed in claim 17, wherein said application server includes an engine for generating said scene description data on the basis of dynamic pages.

19. A publishing system as claimed in claim 17, wherein said application server is adapted to process user form data sent from said wireless device to said presentation server.

20. A publishing system as claimed in claim 1, wherein said application server is adapted to generate image tile data representing an image as a set of tiles and to send at least part of said image tile data to said wireless device for display of part of said image.

21. A publishing system as claimed in claim 19, wherein said presentation server is adapted to send individual tiles of said set of tiles to said wireless device on demand.

22. A publishing system as claimed in claim 4, wherein said presentation server synchronously accesses media sources for said media objects and sends said application data in packets of a bitstream to said wireless device, whilst said wireless device is executing an application using the application data received.

23. A publishing system as claimed in claim 1, wherein said presentation server incrementally links media sources for said media objects and sends said application data incrementally to a wireless device running an application using the received application data.

24. A publishing system as claimed in claim 1, wherein said presentation server is adapted to send said application data to a plurality of wireless devices running an application using the application data, simultaneously.

25. A publishing system as claimed in claim 1, wherein said presentation server sends said application data to said wireless device as a download.

26. A publishing system as claimed in claim 1, wherein said presentation server sends said application data to said wireless device as a data stream.

27. A publishing system as claimed in claim 1, wherein said presentation server sends a portion of said application data to said wireless device as a download, and the remainder of said application data as a data stream.

28. A media player for a wireless device, including a virtual machine for receiving application data for one or more media objects, processing said application data at an object level for said objects in response to detected events and presenting said objects on said device based on said events.

29. A media player as claimed in claim 28, wherein said application data includes content, layout and control logic data for said media objects.

30. A media player as claimed in claim 29, wherein said logic data defines events for said media objects, respectively.

31. A media player as claimed in claim 29 or 30, wherein said content, layout and logic data is sent in media data packets, media definition packets and object control packets, said object control packets including bytecode for instructing said virtal machine.

32. A media player as claimed in claim 28, wherein said virtual machine communicates with a presentation server and compilation of said application data is dynamically controlled on the basis of communications between the virtual machine and the presentation server.

33. A media player as claimed in claim 32, wherein said virtual machine is adapted to send capability data to a presentation server indicating capabilities of said wireless device.

34. A media player as claimed in claim 33, wherein said capabilities include hardware capabilities and software capabilities of said wireless device.

35. A media player as claimed in claim 32, wherein said communications includes data on said events.

36. A media player as claimed in claim 35, wherein said events relate to actions of the user of said wireless device.

37. A media player as claimed in claim 32, wherein said virtual machine is adapted to send user event data to said presentation server.

38. A media player as claimed in claim 32, wherein said presentation server is adapted to receive software packets from a presentation server to modify software capabilities of said wireless device.

39. A media player as claimed in claim 32, wherein said presentation server is adapted to manage a multimedia object library stored on said wireless device.

40. A media player as claimed in claim 32, wherein said virtual machine is adapted to receive image tile data from said presentation server and to display individual tiles of an image.

41. A media player as claimed in claim 40, wherein said virtual machine is adapted to allow zooming and panning of said image on the basis of said image tile data.

42. A media player as claimed in claim 41, wherein said virtual machine is adapted to request individual tiles of said image tile data from said presentation server when required.

43. A media player as claimed in claim 28, wherein said virtual machine receives said application data as a data stream.

44. A media player as claimed in claim 28, wherein said virtual machine receives said application data as a download.

45. A media player as claimed in claim 28, wherein said virtual machine receives a portion of said application data as a download and the remainder of said application data as a data stream.

46. A publishing system for multimedia, including a presentation server for synchronously accessing media sources to compile packets for media objects, sending said packets to a wireless device to execute an application using the packets received, and adjusting compilation of said packets whilst said wireless device runs said application.

47. A publishing system for multimedia, including a presentation server for incrementally linking media sources for media objects, and sending said media objects incrementally to a wireless device running an application using the objects.

48. A publishing system having a presentation server for simultaneously sending application data to a plurality of wireless devices running an application using the application data.
